(19) United States
(12) Patent Application Publication
(10) Pub. No.: US 2026/0336634 A1
(43) Pub. Date: Oct. 29, 2026

(54) METHOD AND APPARATUS FOR EVALUATING THE PERFORMANCE OF A LEARNING NETWORK

(71) Applicants: HYUNDAI MOTOR COMPANY, Seoul (KR); KIA CORPORATION, Seoul (KR)

(72) Inventors: Jae Hyeon PARK, Hwaseong-si (KR); Jae Hoon CHO, Hwaseong-si (KR); Jun Yong CHOI, Hwaseong-si (KR)

(21) Appl. No.: 19/649,730

(22) Filed: Apr. 16, 2026

(30) Foreign Application Priority Data
Apr. 23, 2025 (KR) 10-2025-0053070

(51) Int. Cl. B60W 50/00; G06N 3/042; G06N 3/0985

(52) U.S. Cl. CPC B60W 50/0097; G06N 3/042; G06N 3/0985; B60W 2050/0028

(57) ABSTRACT

A method for evaluating the performance of a learning network includes generating relationship representation information including adjacency data and node feature data based on network representation information extracted from a learning network having a structure and network configuration data, generating, based on the network representation information, static representation information including overall operation data of the learning network, and generating, by a learning model of graph-based performance prediction, based on the relationship representation information and the static representation information, performance evaluation information of the learning network. The adjacency data indicates a connection relationship between layers of the learning network, the node feature data indicates a setting of a hyperparameter applied to the layers, and the overall operation data indicates a total operation amount for the layers.

### CROSS-REFERENCE TO RELATED APPLICATION

The present application claims the benefit of priority to a Korean application 10-2025-0053070, filed in the Korean Intellectual Property Office on Apr. 23, 2025, the entire contents of which are incorporated herein for all purposes by reference.

### TECHNICAL FIELD

The present disclosure relates to methods and apparatus for evaluating performance of a learning network, and more particularly, to methods and apparatus for evaluating performance in a learning network that accurately predicts performance in a target hardware apparatus designated by a user as an apparatus that executes the learning network by reflecting structural characteristics and an amount of operation of the learning network.

### BACKGROUND

An autonomous driving function may be supported in the vehicle, and the autonomous driving may be configured to estimate a route and control the vehicle through recognition of the surrounding environment.

Vehicles may be equipped with various advanced functions to enhance the convenience of drivers. The autonomous driving technology may be one of various functions and may be designed so that the vehicle may recognize the surrounding environment, estimate a driving route, and control itself. Various deep learning-based learning networks may be used to meet a high level of cognitive performance and accurate route establishment required by autonomous driving.

The performance of the learning network may differ depending on, for example, a network structure, a data size, a hardware environment, or the like. Accurate prediction of the performance may contribute to network optimization and improvement of efficiency of resources. The performance prediction of the learning network may use simple regression analysis or an empirical method. Such a method may not reflect complex hierarchical structures and interactions by considering only a single element of the network, for example, the number of layers and the number of parameters, and thus a prediction error of the performance may be large. In addition, an influence of a hardware environment may not be comprehensively reflected, and thus prediction of actual operational performance may not be accurate.

### SUMMARY

Various examples of the present disclosure is to provide methods and apparatus for evaluating performance of a learning network, and more particularly, to methods and apparatus for evaluating performance in a learning network that accurately predicts performance in a target hardware apparatus designated by a user as an apparatus that executes the learning network by reflecting structural characteristics and an amount of operation of the learning network.

Various examples to be solved by the present disclosure are not limited to those mentioned above, and other problems not mentioned will be clearly understood by those of ordinary skill in the art from the following description.

According to the present disclosure, a method performed by an apparatus for a vehicle may comprise generating relationship representation information based on network representation information extracted from a learning network associated with the vehicle, where the network representation information may comprise a structure of the learning network and network configuration data of the learning network, and where the relationship representation information may comprise adjacency data indicating a connection relationship between layers of the learning network and node feature data indicating a setting of hyperparameter applied to the layers of the learning network. The method may comprise generating, based on the network representation information, static representation information, where the static representation information may comprise overall operation data indicating a total operation amount for the layers of the learning network, and generating, by using a learning model of graph-based performance prediction and based on the relationship representation information and the static representation information, performance evaluation information of the learning network. The method may further comprise modifying, based on the performance evaluation information, the learning network, transmitting to the vehicle the modified learning network, and causing, based on the transmitting of the modified learning network, control of the vehicle.

According to the present disclosure, an apparatus for a vehicle may comprise a processor and a memory storing at least one instruction that, when executed by the processor, is configured to cause the apparatus to receive, from the vehicle, data related to a learning network and specification information of a target hardware mounted in the vehicle, and generate, based on source code of the learning network, network representation information associated with a structure of layers of the learning network. The apparatus may further generate, based on the network representation information, relationship representation information indicating connection relationships between the layers and hyperparameter settings of the layers, and static representation information indicating a total computational workload of the learning network. The apparatus may input the relationship representation information and the static representation information to a performance prediction model to generate performance evaluation information of the learning network associated with the target hardware, modify, based on the performance evaluation information, the learning network such that the modified learning network may comprise at least one of updated layers or updated hyperparameter settings corresponding to the target hardware, and cause, based on the modified learning network, performance of autonomous driving of the vehicle.

The static representation information may comprise at least one of a total number of arithmetic operations of layers of the learning network, a batch size used in the learning network, or a total number of activation functions included in the learning network.

The performance prediction model may be an inductive model configured to sample features from neighboring nodes of each node in graph data representing the learning network and aggregate the sampled features to generate node-embedding data, where the node-embedding data may be used for generating the performance evaluation information.

The performance evaluation information may comprise at least one of resource-utilization data of the target hardware executing the learning network or inference-performance data of the target hardware executing the learning network, where the resource-utilization data may comprise at least one of latency of the target hardware, memory usage of the target hardware, or energy consumption of the target hardware, and where the inference-performance data may comprise at least one of inference accuracy information of the learning network, bottleneck-layer information of the learning network, or solution information for enhancing the learning network.

According to the present disclosure, an apparatus for a vehicle may comprise a processor and a memory storing at least one instruction that, when executed by the processor, is configured to cause the apparatus to generate relationship representation information based on network representation information extracted from a learning network associated with the vehicle, where the network representation information may comprise a structure of the learning network and network configuration data of the learning network, and where the relationship representation information may comprise adjacency data indicating a connection relationship between layers of the learning network and node feature data indicating a setting of hyperparameter applied to the layers of the learning network. The apparatus may generate, based on the network representation information, static representation information, where the static representation information may comprise overall operation data indicating a total operation amount for the layers of the learning network, generate, by using a learning model of graph-based performance prediction and based on the relationship representation information and the static representation information, performance evaluation information of the learning network, modify, based on the performance evaluation information, the learning network, transmit to the vehicle the modified learning network, and cause, based on the transmission of the modified learning network, control of the vehicle.

The structure of the learning network may comprise the layers and connections between the layers, where the connections may indicate processing flows of the layers, and where the network configuration data may comprise the setting of the hyperparameter and an operation amount for each layer of the layers.

The at least one instruction, when executed by the processor, may cause the apparatus to generate, by compilation of the learning network, the network representation information, where the network representation information may comprise intermediate representation information related to the structure of the learning network and the network configuration data of the learning network.

The at least one instruction, when executed by the processor, may cause the apparatus to generate, based on the structure, graph data, where the graph data may comprise nodes corresponding to the layers and edges indicating connections between the layers, and where the nodes may comprise node features associated with the network configuration data.

The overall operation data may be generated based on a basic multiply-accumulate value of the learning network, an operation amount of convolution included in the learning network, an operation amount of a fully-connected layer included in the learning network, a size of a batch included in the learning network, and a number of activation functions included in the learning network.

The learning model of graph-based performance prediction may be configured to process the relationship representation information to generate node-embedding data, concatenate the static representation information with the node-embedding data, and input the concatenated information into a fully connected layer to generate the performance evaluation information.

The learning model of graph-based performance prediction may be an inductive model configured to sample features from neighboring nodes of each node in graph data representing the learning network and aggregate the sampled features to generate an embedding.

The learning model of graph-based performance prediction may be trained using a loss function, where the loss function may be configured to apply a mean square error based on a difference between performance evaluation information output through training and performance evaluation information for ground truth being less than or equal to a predetermined threshold, and apply an absolute value error based on the difference being greater than the predetermined threshold.

The performance evaluation information may comprise at least one of resource-utilization data of a target hardware apparatus executing the learning network or inference-performance data of the target hardware apparatus executing the learning network, where the resource-utilization data may comprise at least one of latency of the target hardware apparatus, memory usage of the target hardware apparatus, or energy consumption of the target hardware apparatus.

The inference-performance data may comprise at least one of inference accuracy data of the learning network, bottleneck layer data of the learning network, or solution data for optimization of the bottleneck layer data.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example of modules constituting a performance evaluation apparatus of a learning network;

FIG. 2 shows an example of a method of evaluating performance of a learning network;

FIG. 3 shows an example of a performance evaluation model of a learning network;

FIG. 4 shows an example of graph data;

FIG. 5 shows an example of generation of adjacency data;

FIG. 6 shows an example of a vehicle communicating with another apparatus to transmit and receive data;

FIG. 7 shows an example of a module constituting a vehicle; and

FIG. 8 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated or adjusted based on the feature of hardware-specific adaptation of learning networks using graph-based performance prediction. For example, when performance prediction indicates that an adapted learning network on a target hardware (e.g., a low-power NPU, an embedded GPU, or a CPU-only fallback controller, etc.) may show increased perception latency or reduced inference accuracy, the system may lower certain autonomous driving control features (e.g., reduce braking aggressiveness, increase following distance, or delay lane-change initiation, etc.). Conversely, when the adapted learning network is predicted to meet required performance thresholds (e.g., stable obstacle detection or consistent lane-boundary tracking, etc.), more advanced autonomous driving functions may be enabled or maintained.

One or more auxiliary devices may also be controlled based on the feature of hardware-specific adaptation of learning networks using graph-based performance prediction. For example, when the performance prediction indicates that an adapted learning network running on a target hardware (e.g., a low-power NPU, an embedded GPU, or a CPU-only controller, etc.) may experience increased processing load or thermal limits, the system may adjust auxiliary device operations by reducing the duty cycle of high-load components (e.g., limiting regenerative braking strength, modifying engine-brake engagement timing, or lowering electric-retarder intensity, etc.) to maintain safe system performance. Conversely, when the adapted learning network is predicted to operate within required performance margins, auxiliary devices may be controlled more aggressively (e.g., enabling stronger regenerative braking or faster retarder response, etc.) to enhance driving stability and energy efficiency.

Minimum risk maneuver (MRM) operation(s) may also be controlled based on the feature of hardware-specific adaptation of learning networks using graph-based performance prediction. For example, when the performance prediction indicates that an adapted learning network on a target hardware (e.g., a thermally throttled GPU, a low-power NPU, or a CPU-only fallback controller, etc.) may not maintain reliable perception or planning performance, the vehicle may initiate an MRM by reducing speed, increasing following distance, or safely pulling over to a stop. Conversely, when the adapted learning network is predicted to satisfy required latency and accuracy thresholds (e.g., stable obstacle detection or consistent trajectory prediction, etc.), the system may delay or avoid triggering an MRM unless additional risk conditions are met.

Biased driving operation(s) may also be controlled based on the feature of hardware-specific adaptation of learning networks using graph-based performance prediction. For example, when the performance prediction indicates that an adapted learning network running on a target hardware (e.g., a low-power NPU, an embedded GPU, or a CPU-only controller, etc.) may experience increased latency or reduced perception accuracy near lane edges, the system may adjust the biased driving target to maintain a safer lateral offset (e.g., shifting slightly farther from adjacent vehicles or roadside objects). Conversely, when the adapted learning network is predicted to meet performance thresholds (e.g., stable lane-boundary detection or reliable obstacle classification, etc.), the driving control apparatus may maintain or reduce the biased lateral distance for smoother lane-centered travel.

One or more sensors may also be controlled based on the feature of hardware-specific adaptation of learning networks using graph-based performance prediction. For example, when performance prediction indicates that an adapted learning network on a target hardware (e.g., a low-power NPU, an embedded GPU, or a CPU-only fallback controller, etc.) cannot process high-frequency sensor data fast enough, the system may reduce the sampling rate of selected sensors (e.g., lowering camera FPS or radar sweep rate) or temporarily deactivate non-critical sensors. Conversely, when the adapted learning network is predicted to meet the required latency and accuracy (e.g., stable object-detection timing or sufficient feature-extraction capacity, etc.), the system may increase sensor resolution or enable additional sensors to support enhanced autonomous-driving functions.

An autonomous driving level and/or autonomous driving activation/deactivation may also be controlled based on the feature of hardware-specific adaptation of learning networks using graph-based performance prediction. For example, when the performance prediction indicates that a learning network optimized for a particular target hardware (e.g., an NPU-based control unit, a low-power embedded GPU, or a CPU-only fallback controller, etc.) may not reliably sustain a required inference latency or accuracy, the autonomous driving level may be automatically lowered (e.g., from Level 3 to Level 2) or autonomous driving may be temporarily deactivated. Conversely, when the adapted learning network is predicted to satisfy performance requirements (e.g., stable lane-keeping accuracy, obstacle-detection latency below a threshold, or reduced memory usage under thermal limits, etc.), the system may maintain or re-activate a higher autonomous driving level.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

According to the present disclosure, a method and apparatus are provided for evaluating the performance of a learning network, particularly one used in autonomous driving control. The method enables accurate prediction of the network's performance in a target hardware apparatus designated by a user by reflecting the network's structural and operational characteristics. The learning network may be represented as a graph in which nodes correspond to layers and edges to inter-layer connections. Relationship representation information, including adjacency and node feature data, and static representation information, including overall operation data such as operation counts and batch size, may be generated. A graph-based performance prediction model may process these data to output performance evaluation information reflecting resource usage and inference behavior of the target hardware. The information may include delay, memory use, energy consumption, inference accuracy, or bottleneck layer identification. The evaluated network may then be enhanced and transmitted to a vehicle or external apparatus for execution, allowing accurate, hardware-specific evaluation and enhancement of learning networks for autonomous driving applications.

Hereinafter, examples of the present disclosure will be described with reference to the accompanying drawings.

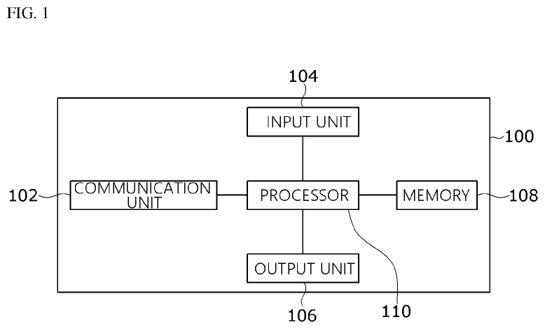

A performance evaluation apparatus of a learning network will now be described with reference to FIG. 1, in accordance with an example of the present disclosure. FIG. 1 shows an example of modules constituting a performance evaluation apparatus of a learning network according to one example of the present disclosure.

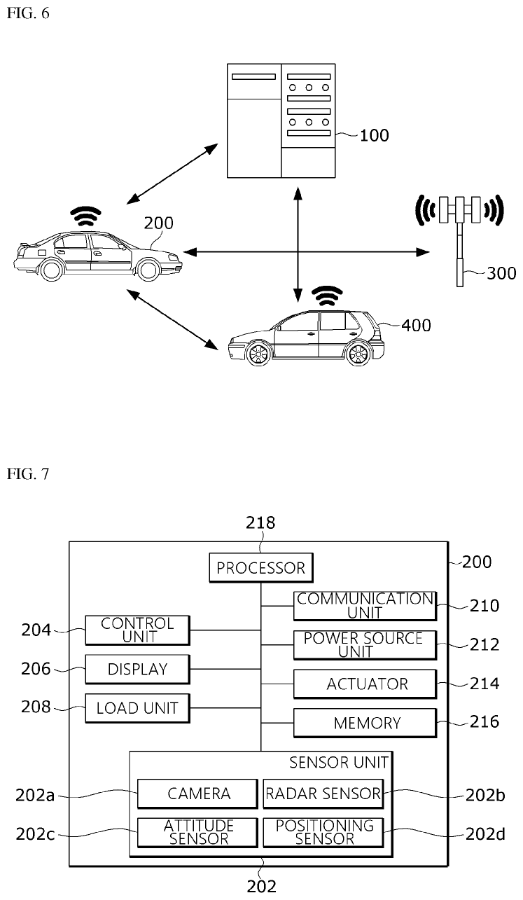

Referring to FIG. 1, the performance evaluation apparatus 100 of the learning network may evaluate performance of a machine learning-based learning network and provide performance evaluation information to a user, a vehicle (see 200, 400 of FIG. 6), or another device that manages the learning network. The learning network may be, for example, a deep learning model for recognizing autonomous driving, setting a route, and controlling the vehicle (e.g., lane-detection models, driving-policy networks, or trajectory-prediction models, etc.).

As another example, the learning network may be a learning model that infers a point of interest, service data related to the point of interest, a driving tendency of a vehicle user, a speech intention of the vehicle user, or the like (e.g., intent-classification networks, recommendation models, or voice-command understanding networks, etc.). The learning network is not limited to the above-described examples and may be a model used in various fields other than the vehicle (e.g., medical diagnosis, retail analytics, or robotics manipulation, etc.). In the present disclosure, the learning network may be used interchangeably with a model, a learning model, a learning algorithm, or the like. In addition, in the present disclosure, for ease of description, the performance evaluation apparatus 100 of the learning network may be referred to simply as a performance evaluation apparatus. Hereinafter, for ease of description, the learning network is illustrated as a model that supports autonomous driving of the vehicle 200, but the following examples may be applied to evaluation of various learning networks in addition to autonomous driving models.

The learning network for recognizing autonomous driving may be, for example, but not limited to, object detection, semantic segmentation, depth estimation, generation of bird's eye images, or the like (e.g., LiDAR-based 3D detection, free-space estimation, or multi-sensor fusion networks, etc.). The learning network for recognition may infer a state of an object based on sensor data for detecting an environment around the vehicle (e.g., camera data, LiDAR point clouds, radar data, or ultrasonic data, etc.).

As an example, the performance evaluation apparatus 100 may train a learning network to be distributed to the vehicle 200, and evaluate the performance of the trained learning network in consideration of specification information of a target hardware apparatus that is to execute the learning network (e.g., CPU-only platforms, embedded GPU boards, or NPU-accelerated devices, etc.). In addition, the performance evaluation apparatus 100 may perform, by using the performance evaluation information, processing of optimizing the learning network constructed in the performance evaluation apparatus 100 for optimal execution in the target hardware apparatus (e.g., by adjusting layer widths, reducing channel sizes, or applying quantization parameters, etc.). As another example, the performance evaluation apparatus 100 may receive source code of the learning network and specification information of the target hardware apparatus from an external apparatus and evaluate the performance of the learning network. The external apparatus may be, for example, another device that trains and distributes the learning network to the vehicle 200 or a vehicle that uses the learning network (e.g., a fleet-management server, cloud-training server, or an edge gateway device, etc.).

The vehicle 200 that receives the evaluated learning network from the performance evaluation apparatus 100 may refer to a movable device. The vehicle 200 is a land vehicle that drives on the land, and may be a conventional passenger or commercial vehicle, a Purpose Built Vehicle (PBV), or the like (e.g., sedans, delivery vans, ride-sharing shuttles, or utility trucks, etc.). The vehicle 200 may be considered a robot in a broad sense, such as a means of mobility, and the robot may be moved using wheels, tracks, or other types of mobility modules (e.g., articulated wheels, omni-directional wheels, or hybrid wheel-track mechanisms, etc.). The vehicle 200 may be driven autonomously or manually.

The vehicle 200 that is autonomously driven may be implemented as semi-autonomous driving or fully autonomous driving. Fully autonomous driving may be provided as autonomous mobility in which the vehicle 200 has full control without user intervention, even if a driving situation is uncertain (e.g., unmarked roads, heavy rain, or dense traffic, etc.). Semi-autonomous driving may be provided as autonomous mobility which requires driver intervention depending on specific driving situations (e.g., construction zones, complex intersections, or adverse weather conditions, etc.).

The learning network according to the present disclosure is not only applied to the vehicle 200 for driving on the land but may be applied to various transportation apparatuses such as a flight mobility apparatus, for example (e.g., drones, eVTOL aircraft, or autonomous air-taxis, etc.).

The performance evaluation apparatus 100 may be, for example, a device separate from the vehicle 200, such as a server, which is operated by a vehicle manufacturer or operated by a management agency that provides autonomous driving services (e.g., a cloud-based OEM server, a mobility-service provider backend, or an infrastructure-control center, etc.). The server (see 100 in FIG. 6) may not only provide performance evaluation information of a learning network but also transmit an application or a learning model for autonomous driving to the vehicle. If the server 100 is operated by the vehicle manufacturer or the management agency that supports autonomous driving, the server may receive connected data of the vehicle 200 or transmit data necessary for autonomous driving. In order to support autonomous driving and various services of the vehicle 200, the server 100 may transmit various information and software modules used for controlling the vehicle 200 to the vehicle 200 in response to a request and data transmitted from the vehicle 200 and a user device (e.g., OTA updates, calibration data, or perception-model patches, etc.). In the present disclosure, an evaluation function of a learning network among various functions of the server will be mainly described.

The performance evaluation apparatus 100 may include a communication unit 102, an input unit 104, an output unit 106, a memory 108, and a processor 110.

The communication unit 102 may support mutual communication with an external apparatus, the vehicle 200, or the like. In the present disclosure, the communication unit 102 may be a communication interface that receives data received from the external apparatus or the vehicle 200. The communication interface may transmit data processed by the processor 110 of the server 100 to the external apparatus or the vehicle 200 (e.g., via Ethernet, CAN, Wi-Fi, or cellular networks, etc.).

The input unit 104 may include an interface for receiving a request from a user. The input unit 104 may be a hardware input interface or a software input interface having a touch-enabled GUI, for receiving a request message related to the performance evaluation of the user (e.g., request for latency prediction, memory-usage estimation, or model-optimization results, etc.). The output unit 106 may include an interface that visually or vocally provides information generated according to the present disclosure. The information may be, for example, performance evaluation information including at least one of resource utilization data or inference performance data of a target hardware apparatus executing a learning network (e.g., predicted delay time, memory footprint, or energy-consumption estimation, etc.).

The memory 108 may store a program and various data for controlling the performance evaluation apparatus 100, so as to load the program or read and write data upon request of the processor 110.

In the present disclosure, the memory 108 may hold a learning model that evaluates performance of a learning network. The learning model may be, for example, a deep learning model of graph-based performance prediction (e.g., a GNN, a message-passing neural network, or a GraphSAGE-based predictor, etc.). The graph-based learning model may input data of a graph structure including a node and an edge connecting the nodes, or data processed to reflect the graph structure, to predict performance evaluation information in the case of when the learning network is processed in a target hardware apparatus.

The memory 108 may manage data for constructing the learning model of the performance prediction, such as performance evaluation information for ground-truth and a learning network for training for training the learning model of performance prediction (e.g., profiling logs, hardware benchmarking data, or training-set networks with known execution metrics, etc.).

The memory 108 may store data related to a learning network. The data may include, for example, source code of the learning network, specification information of a target hardware apparatus to be mounted on a vehicle to execute the learning network, or the like. The specification information includes, for example, but is not limited to, a processing speed, a cache size, a clock frequency, a bandwidth, a delay time, and a capacity related to a CPU (Central Processing Unit), a GPU (Graphical Processing Unit), an NPU (Neural Processing Unit), TPU (Tensor Processing Unit), RAM, a bus, or the like (e.g., DDR bandwidth, on-chip SRAM size, or PCIe throughput, etc.).

The processor 110 may perform overall control of the performance evaluation apparatus 100. The processor 110 may be configured to execute the application and instructions stored in the memory 108. With respect to performance evaluation of a learning network, the processor 110 may execute processing of generating relationship representation information including adjacency data and node feature data based on network representation information extracted from a learning network having a structure and network configuration data. The processor 110 may perform processing of generating, based on the network representation information, static representation information including overall operation data of the learning network (e.g., MAC counts, batch size, or activation-function counts, etc.). The processor 110 may execute processing of generating, by a learning model of graph-based performance prediction, based on the relationship representation information and the static representation information, performance evaluation information of the learning network (e.g., latency prediction, memory-usage prediction, or energy-consumption estimation, etc.). Details of the above-described processes by the processor 110 will be described later.

In addition, the processor 110 may provide the performance evaluation information to the user, the vehicle, or an external apparatus that trains the learning network. As another example, the processor 110 may perform, by using the performance evaluation information, processing of optimizing the learning network constructed in the performance evaluation apparatus 100 for optimal execution in the target hardware apparatus (e.g., pruning parameters, restructuring layers, or applying quantization, etc.).

In the present disclosure, the processor 110 may be implemented as a single processing module as an example. As another example, the processes above-mentioned may be distributed across a plurality of processing modules, and the processor 110 may also be collectively referred to as a plurality of processing modules in the present disclosure.

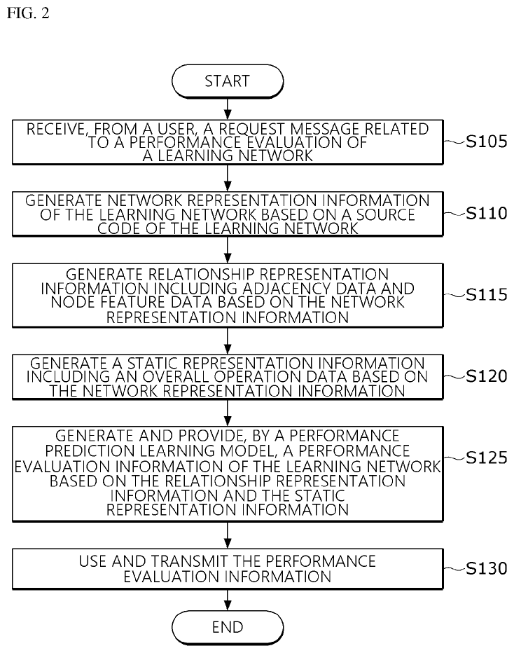

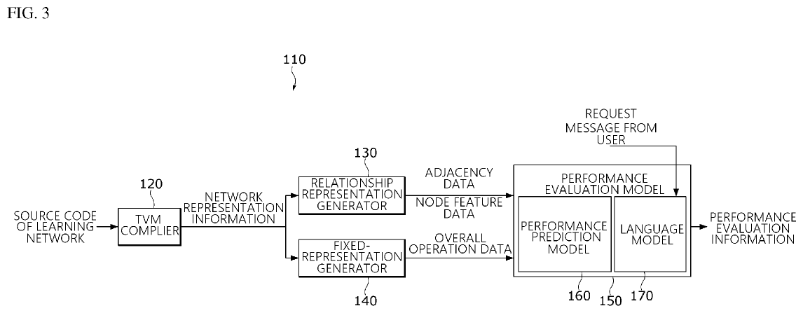

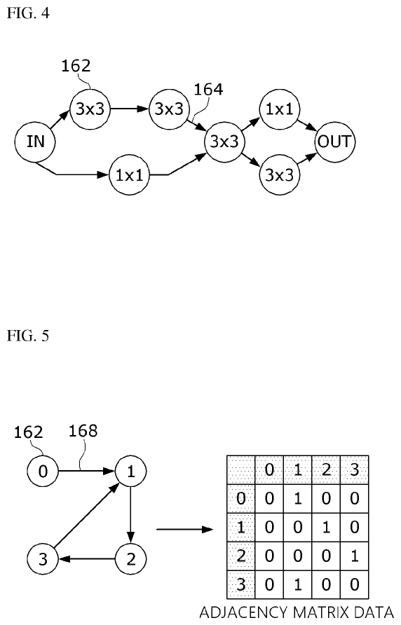

A method of evaluating performance of a learning network will now be described with reference to FIG. 2, FIG. 3, FIG. 4, and FIG. 5, in accordance with another example of the present disclosure. FIG. 2 shows an example of a method of evaluating performance of a learning network according to another example of the disclosure. Hereinafter, it may be illustrated that the performance evaluation apparatus 100 constructs a learning network and evaluates the constructed learning network. The method is mainly performed by the processor 110 of the performance evaluation apparatus 100, but the processor 110 of the generating apparatus may be referred to simply as the performance evaluation apparatus 100 for ease of description, or these terms may be used interchangeably.

Referring to S105 of FIG. 2, the processor 110 of the performance evaluation apparatus 100 may receive, from the user, a request message related to the performance evaluation of the learning network specified by the user (e.g., requests for latency prediction, memory-usage estimation, or bottleneck-layer analysis, etc.).

As illustrated in FIG. 3, the performance evaluation apparatus 100 may be equipped with a language model 170. The language model 170 may determine, for example, a context of a request message input by a user in text, and provide evaluation response information to the output unit 106 so that the performance evaluation information output from the performance evaluation model 150 matches the request message (e.g., generating clarifying prompts, interpreting ambiguous user queries, or mapping user text to hardware-selection queries, etc.). FIG. 3 shows an example of a performance evaluation model of a learning network according to one example of the present disclosure. For example, the language model 170 may be configured as a large language model (LLM).

In response to the input of the request message, the processor 110 may provide, to the output unit 106, a query message for a target hardware apparatus to which the learning network is to be applied. The present disclosure, depending on the specifications of a single hardware apparatus, may not evaluate the learning network based only on the number of layers and the number of learning parameters of the learning network, but evaluate the performance of the learning network in a target hardware apparatus that executes the learning network or that is selected by the user. Accordingly, the processor 110, for example, may provide a list of target hardware apparatus and specification information thereof to the output unit 106 to generate a query message for the user to select at least one target hardware apparatus (e.g., CPU-based systems, embedded GPU boards, or automotive NPUs, etc.). The processor 110 may receive the target hardware apparatus selected in the response message of the user, and load data related to the learning network and the specification information of the target hardware apparatus from the memory 108.

Referring to S110 in FIG. 2, the processor 110 of the performance evaluation apparatus 100 may generate network representation information of the learning network based on the source code of the learning network.

The learning network may be constructed with structure and network configuration data. The learning network may, for example, be constructed trained on a server 100 that performs the functions of the performance evaluation apparatus 100. The learning network, for example, may be a deep learning model (e.g., convolutional networks, transformer-based models, or encoder-decoder architectures, etc.).

The deep learning-based learning network may include, for example, a pre-processing module that pre-processes input data, a feature extraction module that extracts features, and an inference module that predicts or infers output data based on the features. The pre-processing module may, for example, be a pre-processor that removes noise from the input data or converts the input data into various formats (e.g., resizing, normalization, or sensor fusion alignment, etc.). The feature extraction module may be, for example, an encoder. For example, if the learning network is for object detection, semantic segmentation, depth estimation, and generation of bird's-eye images, the encoder may extract feature vectors from sensor data that detects the surrounding environment (e.g., camera RGB images, LiDAR point clouds, or radar Doppler maps, etc.). The inference module may be, for example, a decoder that processes classification or prediction of object states. For example, if the learning network is for object detection, semantic segmentation, depth estimation, and generation of bird's-eye images, the decoder may perform up-sampling, merging of intermediate feature data, generation of estimation probabilities, or the like (e.g., skip-connection fusion, probability-map generation, or spatial feature aggregation, etc.).

At least one of the encoders, the decoder or the pre-processor may have structure and network configuration data.

The structure may include a layer corresponding to a component constituting the encoder, the decoder, or the pre-processor and a connection between the layers. The layers may include, for example, a layer constituting a convolution, a layer constituting a transformer, a layer of a fully connected layer, a layer related to an activation function, a layer related to summation or multiplication, a layer associated with up sampling, and a layer related with generation of an estimation probability (e.g., ReLU blocks, attention layers, or deconvolution layers, etc.). The layers are not limited to the above-described examples and may include a layer that processes various operations. The connection may represent a processing flow of the layer. For example, if the convolution is composed of a plurality of layers sequentially arranged, and input data is processed according to an arrangement order to output a feature, a flow of layers on which the input data is processed may be a connection of the learning network. In addition, if a feature extracted from the layers of the convolution is input to the fully connected layer or the decoder, a flow of the layers processed from the layers of convolution toward the layers of the fully connected layer and the layers of the decoder may be a connection.

The network configuration data may include, for example, a setting of a hyperparameter used for each layer and an amount of operation for each layer (e.g., filter size, stride value, or number of channels, etc.). A parameter trained in a learning network is a learning parameter, and the hyperparameter may be a parameter set by a user or the processor 110 through training. The learning parameter may be, for example, weight of a filter, weight of a fully connected layer, a bias, and the like. The hyperparameter used in a layer constituting convolution may include a filter, a stride, channels, and padding, for example. According to this example, the setting of the hyperparameters may include a size of a filter, a movement value of a stride, the number of channels, the number of pixels involved in padding, or the like, for example. In addition, the hyperparameter for training may include a learning rate, an epoch, and the number of layers in the encoder and the decoder, for example (e.g., optimizer settings, decay schedules, or warmup steps, etc.).

The operation amount includes, for example, but is not limited to, a basic multiplication-accumulation value of a learning network, an operation amount between each layer of convolution and a filter, an operation amount of fully connected layers, a size of a batch, and the number of activation functions (e.g., MAC counts, FLOPs, or activation-call counts, etc.).

The processor 110 may generate, by compilation of the learning network, network representation information, based on source code of the learning network. The source code may be, for example, source code described by PyTorch, Tensorflow, ONNX, or the like (e.g., scripted Python models, ONNX graph files, or serialized checkpoint formats, etc.).

The network representation information may be generated to have intermediate representation information and graph data. The intermediate representation information may be generated to have information related to the structure and network configuration data extracted from the learning network. The processor 110 may generate graph data based on intermediate representation information. The graph data may include a node 162 corresponding to a layer and an edge 164 indicating a connection between the layers, based on the structure of the learning network, as illustrated in FIG. 4. FIG. 4 shows an example of graph data. The node 162 may be generated to have a node feature based on the network configuration data. In FIG. 4, the node feature in the node 162 is illustrated to be a size of a filter (e.g., 3×3, 5×5, or 7×7, etc.).

The compilation may be processed using, for example, a Tensor Virtual Machine (TVM) compiler 120, as shown in FIG. 3. The TVM compiler 120 may convert input forms of various deep learning-based learning networks into intermediate representation information (IR) that is integrated and extracted into single domain information. In addition, the TVM compiler 120 may generate intermediate representation information optimized for the target hardware apparatus.

For example, although the input learning network is described as various types of model results such as PyTorch, Tensorflow, ONNX, or the like, a single integrated IR result may be extracted by the TVM compiler 120 by utilizing any type of model result. The IR may be provided as a high-level representation of the learning network information (e.g., computational graph nodes, operator sequences, or tensor-layout data, etc.). Specifically, the TVM compiler 120 may extract intermediate representation information from the source code of the learning network by utilizing a TVM relay parser in the public domain.

Referring to S115 of FIG. 2, the processor 110 may generate relationship representation information including adjacency data and node feature data based on the network representation information.

The processor 110 may generate the relationship representation information by using the relationship representation generator 130, as illustrated in FIG. 3. In addition, the processor 110 may generate adjacency data and node feature data, for example, based on the intermediate representation information and the node feature. The relationship representation generator 130 functions as a kind of pre-processor on the graph data, so that the graph data may be converted into relationship representation information, that is, adjacency data and node feature data, generated in a graph format input to the performance prediction model 160 of the performance evaluation model 150. The generation of the graph relationship information (or the graph representation) may be used to model relationships between components (e.g., convolutions, activation functions, or normalization layers, etc.) in the learning network.

The adjacency data output from the relationship representation generator 130 may be generated to indicate a connection relationship 168 between the layers 162 of the learning network, as illustrated in FIG. 5. The adjacency data may be generated to indicate a connection relationship between nodes of the graph data (e.g., forward edges, skip connections, or parallel-branch paths, etc.). The adjacency data may be formed into matrix data indicating the connection relationship 168, in order to be generated to suitable the input of the performance prediction model 160. FIG. 5 shows an example of generation of adjacency data.

The node feature data output from the relationship representation generator 130 may be generated to indicate the setting of the hyperparameter applied to the layer (e.g., channel count, filter size, or stride value, etc.). The node feature data may be formed into matrix data indicating the setting of the hyperparameter applied to a layer, in order to be generated to be suitable for the input of the performance prediction model 160 to be described later.

Referring to S120 of FIG. 2, the processor 110 may generate the static representation information including the overall operation data of the learning network based on the network representation information.

The processor 110 may generate the static representation information by using the fixed-representation generator 140, as illustrated in FIG. 3. In addition, the processor 110 may generate the overall operation data, for example, based on the intermediate representation information (e.g., IR operator logs, tensor-shape information, or hardware-specific relay data, etc.). The overall operation data may indicate a total operation amount for the layers.

The fixed-representation generator 140 may generate information related to compilation of a learning network, for example, an operation in a layer that is not included by the TVM compiler 120 (e.g., custom CUDA kernels, normalization blocks, or model-specific activation modules, etc.). An operator of a layer that cannot be generated by the TVM Compiler 120 may be, for example, a convolution (Conv2D), a convolution transpose (Conv2 D transpose), a fully connected layer, a batch matrix multiplication, and the like (e.g., group convolutions, deformable convolutions, or channel-attention operators, etc.). The total number of operators, for example, total number of multiply-accumulate (MACs), may be derived by the relationship representation generator 130. The fixed-representation generator 140 may concatenate the total number of operators to output the fixed static representation information.

The overall operation data may be generated by a concatenation of the number of total operators. The overall operation data may be generated based on a basic multiply-accumulate value of the learning network, an operation amount of convolution included in the learning network, an operation amount of a fully-connected layer included in the learning network, a size of a batch included in the learning network, and the number of activation functions included in the learning network, for example (e.g., ReLU counts, GELU counts, or softmax-use counts, etc.). The overall operation data may be generated by using the following Equation (1).

$$\begin{matrix}Equation ( 1 ) & \\ {ℱ}_{s} ← {ℱ}_{mac} ⊕ {ℱ}_{batch} ⊕ {ℱ}_{Tconv} ⊕ {ℱ}_{Tdense} ⊕ {ℱ}_{Trelu} . & a\end{matrix}$$

where, F_s is static representation information, F_mac is the base multiply-accumulate value of the learning network, F_batch is the size of the batch, F_Tconv is the total number of operations of the overall convolution, F_Tdense is the total number of operations of fully connected layers, and F_Trelu is the total number of activation functions. In addition, ⊕ represents a concatenation.

The static representation information, along with the relationship representation information, may be input to the performance prediction model 160 and utilized to increase the understanding of the information of the learning network (e.g., identifying computational hotspots, estimating hardware bottlenecks, or predicting layer-wise execution trends, etc.).

Referring to S125 in FIG. 2, the processor 110 may generate, by the performance evaluation model, the performance evaluation information of the learning network based on the relationship representation information and the static representation information.

The performance evaluation model 150 may include a learning model of graph-based performance prediction. As an example, as illustrated in FIG. 3, the performance evaluation model 150 includes a performance prediction model 160 and a language model 170. In this example, the performance prediction model 160 may generate information related to performance evaluation information, such as a graph tokenized feature, and the language model may generate performance evaluation information according to a request message based on the information and provide the performance evaluation information to the output unit 106 (e.g., natural-language summaries, clarified inference results, or user-readable explanations, etc.). As another example, if the language model is not included in the performance evaluation model 150, the performance prediction model 160 may generate the performance evaluation information in a format discernable by a user and provide it through the output unit 106. In the following, the performance evaluation model 150 is illustrated as including the performance prediction model 160 and the language model 170, but the following may also be applied to the performance evaluation model 150 constructed with the performance prediction model 160 without the language model 170 as long as there is no technical contradiction.

The performance prediction model 160 may be constructed as, for example, a graph-based deep learning model (e.g., GNNs, message-passing networks, or GraphSAGE-based predictors, etc.). The performance prediction model 160 is, for example, an inductive model that samples features from neighboring nodes of each node and aggregates the sampled features to generate an embedding, and may be, as a specific example, the GraphSAGE model.

According to the graph-based inductive model, the performance prediction model 160 may be configured to process the relationship representation information to generate the node embedding data, combine the static representation information with the node embedding data (e.g., node-embedded relationship representation information), and input the combined information into a fully connected layer to generate the performance evaluation information (e.g., predicted latency, memory footprint, or energy-consumption estimates, etc.).

A graph-based inductive model is easy to interpret after defining the relationship between nodes and edges of a graph. On the other hand, a graph-based transductive model may have a fixed graph structure and may not be predictable for a model having another structure. The graph-based inductive model may generate meaningful embedding results even for unseen new data in a learning process without prior training (e.g., new model topologies, alternative layer graphs, or modified encoder-decoder structures, etc.). In other words, the inductive model may be a graph neural network framework that learns node embeddings in a large-scale graph, and through inductive learning, information of nodes and neighbors may be aggregated and generalized to unseen nodes. The model may generate a fixed size embedding to learn a feature and a local graph structure and generate a node embedding sensitive to a local neighbor for an unseen new node by using a neighbor aggregation technique.

The performance prediction model 160 may generate, based on the relationship representation information and the static representation information, information related to performance evaluation information of the learning network. For example, the performance prediction model 160 may be configured with an encoder that generates information related to the performance evaluation information to generate a graph tokenized feature related to the performance evaluation information (e.g., vectorized performance tokens, layer-criticality embeddings, or throughput-sensitive feature codes, etc.).

The language model 170 may generate performance evaluation information based on the graph tokenized feature and the request message and provide the performance evaluation information to the output unit 106. The performance evaluation information may include at least one of resource utilization data or inference performance data of a target hardware apparatus designated as an apparatus to execute the learning network in the request message. The resource utilization data may include, for example, at least one of a delay time, a memory usage amount, or an energy consumption amount (e.g., DRAM bandwidth use, cache-hit degradation, or compute-saturation metrics, etc.). The inference performance data may include at least one of inference accuracy data of the learning network, bottleneck layer data of the learning network, or solution data for optimization of the bottleneck layer data, for example (e.g., pruning suggestions, channel-reduction proposals, or layer-depth adjustment hints, etc.).

By way of example, when the request message includes describing a feature of the learning network, the performance evaluation information may be generated by using a ResNet as a backbone of the learning network (e.g., variants of Residual Neural Network such as ResNet-18, ResNet-34, or ResNet-50, etc.). When the request message includes identifying a bottleneck layer or requesting an optimization solution when the learning network is executed on the target hardware apparatus, the performance evaluation data may provide bottleneck layer data indicating that the specific layer of the convolution is the bottleneck layer, or solution data indicating that the number of channels used for the specific layer of convolution is to be changed to 128. In addition, the request message may also indicate a delay time, an expected reduction time of memory usage, or an expected reduction amount according to the change.

According to another example, the performance prediction model 160 of the performance evaluation model 150 without the language model 170 may include an encoder and a decoder that provides performance evaluation information based on output data generated by the encoder. The decoder may provide the performance evaluation information to the output unit 106 in a format that may be identified by a user (e.g., numerical tables, heat maps, or layer-wise performance summaries, etc.).

Referring to S130 of FIG. 2, the processor 110 may optimize a learning network by using the performance evaluation information, may apply the learning network, or may transmit the performance evaluation information to the vehicle 200 and an external apparatus (e.g., a cloud-training server, a developer workstation, or an OTA-update management system, etc.).

The performance prediction model 160 may be trained according to the following. The training may be performed on the performance prediction model 160 alone or on a combination including the relationship representation generator 130, the fixed representation generator, and the performance prediction model 160. For ease of description, the training of the performance prediction models 160 will be mainly described. The performance prediction models 160 may be trained by using training input data including a plurality of learning networks (or source codes thereof) and performance evaluation information for ground-truth. The performance evaluation information for the ground-truth may include performance evaluation information of the learning networks actually measured for a plurality of target hardware apparatus (e.g., CPU-based embedded modules, GPU-based ADAS ECUs, or NPU-accelerated boards, etc.).

The training of the performance prediction models 160 may be performed by using a predetermined loss (or loss function). For example, the loss may be a loss function in which a square error is applied when an error between the performance evaluation information output through training and the performance evaluation information for ground-truth is less than or equal to a predetermined error, and an absolute value error is applied when the error is greater than the predetermined error. The performance prediction model 160 trained by using such a loss may exhibit superior performance compared to a mean square error (MSE) loss and an L1 loss.

According to the present disclosure, performance evaluation of a learning network is performed on a target hardware apparatus designated by a user without depending on specification information of a single hardware apparatus, so that performance may be accurately evaluated. In addition, evaluation of learning networks may be performed on a high-performance server rather than an embedded environment (e.g., batch evaluation on server-class GPUs, cloud containers, or distributed inference clusters, etc.). Meanwhile, in the performance prediction model 160, input resolutions for the relationship representation information and the static representation information and are combined for each learning network, so that performance evaluation information may be generated as an image such as a heat map (e.g., latency-heat maps, memory-hotspot maps, or operator-congestion maps, etc.). Accordingly, when an optimal learning network is searched, a search space may be expanded, and resolution may be increased.

The vehicle 200 that receives the learning network diagnosed by the performance evaluation information generated in FIG. 2 and another device that communicates with the server 100 will be described.

FIG. 6 shows an example of a vehicle communicating with another apparatus to transmit and receive data.

The vehicle 200 may refer to a device that may move to a specific point, as described above. Although the present disclosure describes the vehicle 200 as a vehicle driving on the land as an example, the present disclosure may also be applied to a mobility apparatus for flight or water transportation (e.g., UAV-type air mobility, personal air taxis, or autonomous marine vessels, etc.). The vehicle 200 may be controlled to drive by autonomous driving, as described above in FIG. 1, and the autonomous driving may be implemented as semi-autonomous driving or fully autonomous driving.

The vehicle 200 may be powered by electric energy or fossil energy. For the electric energy, the vehicle 200 may employ, for example, a pure battery-based vehicle driven only by a high-voltage battery or a gas-based fuel cell as an energy source. In addition, the fuel cell may utilize various types of gas capable of generating electric energy, and the gas may be hydrogen as an example (e.g., compressed hydrogen, liquid hydrogen, or reformate gas, etc.). However, the present disclosure is not limited thereto, and various gases may be applicable. For the fossil energy, the vehicle 200 is driven based on a fuel such as gasoline, diesel, or liquefied gas, and may be equipped with an engine that drives a wheel included in the actuator 214 by combustion of the fuel. The engine may be included in the power source unit 212 from the viewpoint of providing a driving rotational force of the wheel to the actuator 214. As another example, the vehicle 200 may also be driven in a hybrid manner of electric energy and fossil energy (e.g., plug-in hybrid mode, mild hybrid mode, or series hybrid mode, etc.).

Meanwhile, the vehicle 200 may perform communication with the other devices 100, 300 or the other vehicle 400. The other devices may include, for example, the performance evaluation apparatus 100 that supports various controls, state management, and driving of the vehicle 200, an ITS device 300 for receiving information from an ITS, various types of user devices, or the like (e.g., smartphones, tablets, or wearable devices, etc.). The performance evaluation apparatus 100 may be, for example, an external device operated by a vehicle manufacturer or operated by a management agency that services autonomous driving, as described above in FIG. 1.

The ITS device 300 is, for example, a Road Side Unit (RSU), and the ITS device 300 may interchange vehicle recognition data, driving control and state data, environmental data around the vehicle, map data, or the like through V2I with the vehicle 200 to assist the user in driving the own vehicle or support autonomous driving of the vehicle 200. The vehicle 200 may interchange the above-listed data through V2V with the other vehicle 400 to support driving of the own vehicle or autonomous driving.

Vehicle 200 may communicate with other vehicles or other devices based on Cellular communication, Wireless Access in Vehicular Environment (WAVE) communication, Dedicated Short Range Communication (DSRC) or near field communication, or other communication schemes (e.g., Bluetooth LE, Ultra-Wideband (UWB), or Wi-Fi Direct, etc.).

For example, for the vehicle 200 to communicate with the server 100, the ITS device 300, and the other vehicle 400, a communication network such as LTE or 5G, a WiFi communication network, a WAVE communication network, or the like may be used as a cellular communication network. For another example, a DSRC or the like used in the vehicle 200 may also be used for communication between vehicles. A communication manner between the vehicle 200, the server 100, the ITS device 300 and the other vehicle 400, and a user device is not limited to the foregoing examples.

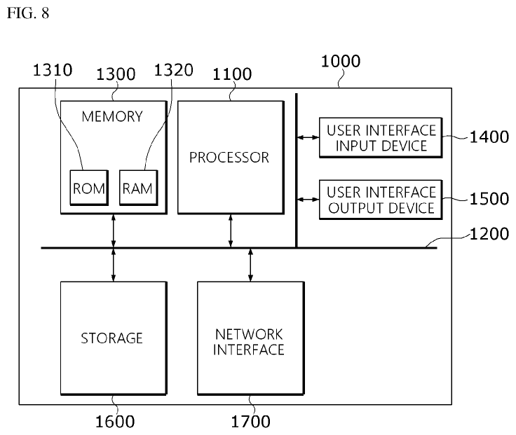

FIG. 7 shows an example of a module constituting a vehicle according to the present disclosure.

The vehicle 200 may include a sensor unit 202, an operation unit 204, a display 206, a load unit 208, and a communication unit 210.

The sensor unit 202 may include various types of sensors for sensing various states and situations occurring in an external surrounding environment, an internal system, a user operation, and a boarding space of the vehicle 200 (e.g., environmental sensors, driver-monitoring sensors, or cabin-state sensors, etc.).

Specifically, the sensor unit 202 may include an image sensor (e.g., an externally oriented camera 202a), a radar sensor 202b, or the like so as to recognize dynamic and static objects existing around the vehicle 200.

The camera 202a may generate image data by recognizing an external object as an image during use of the vehicle 200 and transmit the image data to the processor 218. The camera 102a may be mounted on a specific site of the vehicle 200, for example, a front site, a rear site, or side sites of the vehicle 200. If a plurality of image sensors 202a are mounted on each site, it may be referred to as a multi-camera in the present disclosure. The image data obtained by the plurality of image sensors 102a may be referred to as a multi-view image data or a multi-view (e.g., front-view, rear-view, side-view, or fisheye 360°-view, etc.).

The radar sensor 202b may generate radar data through radio waves reflected from an external object by emitting radio waves of specific frequencies around the vehicle 200 in order to get the presence, relative distance, speed, direction, or the like of the external object. Although an example in which a lidar sensor (not shown) is not mounted is illustrated in the present disclosure, in another example, the lidar sensor may be mounted on the vehicle 200 (e.g., solid-state lidar, scanning lidar, or flash lidar, etc.).

The sensor unit 202 may include an attitude sensor 202c. The attitude sensor 202c may detect, for example, states for each of three axes of the vehicle 200, such as yaw, pitch, and roll, and output various attitude states of the vehicle based on the above-described factors. The attitude sensor may include, for example, an IMU sensor, a gyro sensor, or the like. The processor 218 may generate attitude data based on the attitude state.

In addition, the sensor unit 202 may include a positioning sensor 202d for confirming the position of the vehicle 200. The positioning sensor 201d is, for example, but not limited to, a GPS sensor or a GNSS sensor (e.g., dual-frequency GNSS, RTK-GPS, or differential GNSS, etc.).

The present disclosure describes the sensors of the sensor unit 202 referred to in the description and may further include sensors that sense various situations not listed therein (e.g., rain sensors, cabin-occupancy sensors, or tire-pressure sensors, etc.).

The operation unit 204 may be configured as a module for a user to steer for driving. For example, the operation unit 204 may be a steering wheel for manual driving, an automatic or manual transmission actuator, an accelerator pedal, a brake pedal, a gear transmission, or the like. The operation unit 204 may further include an interface for using, releasing, and selecting a detailed function of an autonomous driving mode requested by the user, so that the user uses the autonomous driving function.

The display 206 may function as a user interface. The display 206 may be displayed by the processor 218 to output an operation state of the vehicle 200, a control state, route/traffic information, remaining energy information, content requested by the driver, or the like. In addition, the display 206 may be configured as a touch screen capable of detecting a driver input, so as to receive a request from the driver instructing the processor 218. (e.g., selecting a route, activating ADAS modes, or confirming a software update, etc.)

The load unit 208 is mounted on the vehicle 200 and may be a type of non-driving electric apparatus excluding a driving power system such as a wheel driving unit (not shown). The load unit 208 is an auxiliary instrument that receives power from the power source unit 212, and may be, for example, an air conditioning system, an indicator lamp system, a lighting system, a seat system, and various apparatus installed in the vehicle 200 (e.g., infotainment units, wireless charging pads, or door-control modules, etc.).

The communication unit 210 may support mutual communication with the server 100, the ITS device 300, the surrounding vehicle 400, or the like. The communication unit 210 may include, for example, a module that processes cellular communication, WAVE, DSRC communication, or the like. In the present disclosure, the communication unit 210 may transmit data generated or stored during driving to the server 100 and receive data and a software module transmitted from the server 100. The communication unit 210 may support communication for transmitting or receiving signals related to data, control, commands, and requests between the components in FIG. 7. The components may be instruments or modules referred to as reference numerals 202 to 218 illustrated in FIG. 7, for example. The communication unit 210 may transmit signals transmitted between the components, that is, signals related to the data, the control, the commands, and the requests, to a communication bus by using CAN (Controller Area Network) communication, for example, and transmit the signals to a specific component. The data, control, the commands, and the requests transmitted in the CAN communication may be referred to as CAN data (e.g., diagnostic data, actuator-control signals, or sensor-status updates, etc.). The communication unit 210 may also support communication with an electronic device carried by an occupant inside the vehicle 200 (e.g., smartphone pairing, wearable-device data, or smart-key operations, etc.). The vehicle 200 may also include a power source unit 212 and an actuator 214.

The power source unit 212 may generate and supply power and electric power to be used for a driving power system and a non-driving power system, such as the actuator 214. The non-driving power system may be, for example, the sensor unit 202, the operation unit 204, the display 206, the load unit 208, the communication unit 210, or the like, and may include, but not limited thereto, various components implementing sensing, interfacing, communicating, and convenience functions except for components directly involved in a driving operation (e.g., cabin-control modules, infotainment systems, or HVAC units, etc.).

The actuator 214 includes at least one module that implements a driving operation and may execute the driving operation based on a user request from the operation unit 204 or a signal according to a request of the processor 218. The signal according to the request may be related to, for example, at least one of a longitudinal control such as acceleration and deceleration, a lateral control such as steering, and a gear shift. Here, the gear shift may be processed by a request of manual driving by a user using a gear transmission or by the processor 218 in autonomous driving.

The actuator 214 may include a wheel driving unit (not shown), a mechanical component for implementing a driving operation on the wheel driving unit, and an electronic module to perform a driving operation according to a command of the processor 218 by a user's manual operation or autonomous driving. When the vehicle 200 is operated based on electric energy, it may also include an assembly for transmitting a requested driving operation to the wheel driving unit (not shown) (e.g., an inverter, motor controller, or reduction gear, etc.). When the vehicle 200 is operated based on fossil energy, the actuator 214 may include a transmission and a gear module for transmitting power of an internal combustion engine (e.g., torque converter, clutch pack, or multi-stage gearbox, etc.).

The wheel driving unit may include a plurality of wheels, a driving force generation module for generating a driving force and applying or transmitting the driving force to the wheels, a braking module for decelerating driving of the wheels, a steering module for realizing lateral control of the wheels, or the like. When the vehicle 200 is driven based on electric energy, the driving force generation module may be configured as a motor assembly that generates a driving force based on electric power output from an electric battery. The braking module of the electric-based vehicle 200 may further have a regenerative braking function (e.g., energy recovery during deceleration, blended braking, or one-pedal operation, etc.).

The vehicle 200 may also include a memory 216 and a processor 218.

The memory 216 may store an application and various data for controlling the vehicle 200, so as to load the application or read and write data upon request of the processor 218. In the present disclosure, the memory 216 may receive and manage the evaluated learning network from the server 100. In addition, the memory 216 may receive and manage information necessary for driving, such as map information, traffic information, weather information, accident information, or the like (e.g., HD map tiles, V2X alerts, or real-time congestion data, etc.).

The processor 218 may perform overall control of the vehicle 200. The processor 218 may be configured to execute the application and instructions stored in the memory 216. The processor 218 may utilize the learning network evaluated in FIG. 2 to perform operation control, such as driving control, of the vehicle based on sensor data that detects the surrounding environment. For instance, the learning network may be constructed to control the autonomous driving of the vehicle 200 (e.g., lane-keeping, object detection, or trajectory planning, etc.). If the learning network is evaluated and optimized according to, for example, specification information of the processor 218 and the memory 216, the learning network may be executed without delay while efficiently using resources in the vehicle 200 (e.g., reduced latency, reduced memory footprint, or improved inference throughput, etc.).

In the present disclosure, the processor 218 may be implemented as a single processing module as an example. As another example, the processes above-mentioned may be distributed across a plurality of processing modules, and the processor 218 may also be collectively referred to as a plurality of processing modules in the present disclosure (e.g., an AI accelerator, a vision processor, or a microcontroller cluster, etc.).

FIG. 8 shows an example computing system (e.g., a computing device of a vehicle or any other apparatus). One or more controllers, processors, etc. described herein, such as one or more components of the vehicle 100, one or more components of the server 200, one or more components of another vehicle 400, and any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a method of evaluating performance of a learning network, the method comprising: generating relationship representation information including adjacency data and node feature data based on network representation information extracted from a learning network having a structure and network configuration data; generating, based on the network representation information, static representation information including overall operation data of the learning network; and generating, by a learning model of graph-based performance prediction, based on the relationship representation information and the static representation information, performance evaluation information of the learning network. The adjacency data indicates a connection relationship between layers of the learning network, the node feature data indicates a setting of a hyperparameter applied to the layers, and the overall operation data indicates a total operation amount for the layers.

In some implementations, the structure of the learning network may include the layers and connections between the layers, the connections may indicate processing flows of the layers, and the network configuration data may include setting of the hyperparameter and an operation amount for each layer.

In some implementations, the method may further comprise generating, by compilation of the learning network, the network representation information including intermediate representation information related to the structure and the network configuration data extracted from the learning network.

In some implementations, the generating the network representation information may further comprise generating, based on the structure, graph data comprising nodes corresponding to the layers and edges indicating connections between the layers, the nodes having node features based on the network configuration data.

In some implementations, the overall operation data may be generated based on a basic multiply-accumulate value of the learning network, an operation amount of convolution included in the learning network, an operation amount of a fully-connected layer included in the learning network, a size of a batch included in the learning network, and the number of activation functions included in the learning network.

In some implementations, the learning model of the performance prediction may be implemented to process the relationship representation information into a node embedding, concatenate the static representation information into the node embedded relationship representation information, and input the concatenated information into a fully connected layer to generate the performance evaluation information.

In some implementations, the learning model of the performance prediction may be an inductive model that samples features at neighboring nodes of each node and aggregates the sampled features to generate an embedding.

In some implementations, the learning model of the performance prediction may be trained using a loss that applies a mean square error when an error between the performance evaluation information output through training and the performance evaluation information for ground-truth may be less than or equal to a predetermined error, and applies an absolute value error when the error is greater than the predetermined error.

In some implementations, the performance evaluation information may include at least one of resource utilization data or inference performance data of a target hardware apparatus executing the learning network, the resource utilization data may include at least one of latency, memory usage, or energy consumption.

In some implementations, the inference performance data may include at least one of inference accuracy data of the learning network, bottleneck layer data of the learning networks, or solution data for optimization of the bottleneck layer data.

According to another example of the present disclosure, an apparatus of evaluating performance of a learning network, the apparatus comprising: a memory storing at least one instruction; and at least one processor to execute the at least one instruction stored in the memory. The at least one processor is configured to: generate relationship representation information including adjacency data and node feature data based on network representation information extracted from a learning network having a structure and network configuration data; generate, based on the network representation information, static representation information including overall operation data of the learning network; and generate, by a learning model of graph-based performance prediction, based on the relationship representation information and the static representation information, performance evaluation information of the learning network. The adjacency data indicates a connection relationship between layers of the learning network, the node feature data indicates a setting of a hyperparameter applied to the layers, and the overall operation data indicates a total operation amount for the layers.

According to the present disclosure, it is possible to provide a method and apparatus that accurately generate various types of road information based on route data to support vehicle driving.

The effects of the present disclosure are not limited to those mentioned above, and other effects not mentioned will be clearly understood by those skilled in the art from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus for a vehicle, the method comprising:
based on network representation information extracted from a learning network associated with the vehicle, generating relationship representation information, wherein the network representation information comprises a structure of the learning network and network configuration data of the learning network, and wherein the relationship representation information comprises:
adjacency data indicating a connection relationship between layers of the learning network, and
node feature data indicating a setting of hyperparameter applied to the layers of the learning network;
generating, based on the network representation information, static representation information, wherein the static representation information comprises overall operation data indicating a total operation amount for the layers of the learning network;
generating, by using a learning model of graph-based performance prediction and based on the relationship representation information and the static representation information, performance evaluation information of the learning network;
modifying, based on the performance evaluation information, the learning network;
transmitting, to the vehicle, the modified learning network; and
causing, based the transmitting of the modified learning network, control of the vehicle.

2. The method of claim 1,
wherein the structure of the learning network comprises the layers and connections between the layers,
wherein the connections indicate processing flows of the layers, and wherein the network configuration data comprises the setting of the hyperparameter and an operation amount for each layer of the layers.

3. The method of claim 1, further comprising:
generating, by compilation of the learning network, the network representation information, wherein the network representation information comprises intermediate representation information related to the structure of the learning network and the network configuration data of the learning network.

4. The method of claim 3,
wherein the generating of the network representation information comprises generating, based on the structure, graph data,
wherein the graph data comprises nodes corresponding to the layers and edges indicating connections between the layers,
wherein the nodes comprise node features associated with the network configuration data.

5. The method of claim 1, further comprising:
generating the overall operation data based on:
a basic multiply-accumulate value of the learning network,
an operation amount of convolution included in the learning network,
an operation amount of a fully-connected layer included in the learning network,
a size of a batch included in the learning network, and
a number of activation functions included in the learning network.

6. The method of claim 1, further comprising:
processing, based on the learning model, the relationship representation information to generate node embedding data;
concatenating the static representation information with the node embedding data; and
inputting the concatenated information into a fully connected layer to generate the performance evaluation information.

7. An apparatus for a vehicle, the apparatus comprising:
a processor; and
a memory storing at least one instruction that, when executed by the processor, is configured to cause the apparatus to:
receive, from the vehicle, data related to a learning network and specification information of a target hardware mounted in the vehicle,
generate, based on source code of the learning network, network representation information associated with a structure of layers of the learning network,
based on the network representation information, generate:
relationship representation information indicating connection relationships between the layers and hyperparameter settings of the layers, and
static representation information indicating a total computational workload of the learning network,
input the relationship representation information and the static representation information to a performance prediction model to generate performance evaluation information, of the learning network, associated with the target hardware,
modify, based on the performance evaluation information, the learning network, wherein the modified learning network comprises at least one of updated layers or updated hyperparameter settings corresponding to the target hardware, and
cause, based on the modified learning network, performance of autonomous driving of the vehicle.

8. The apparatus of claim 7, wherein the static representation information comprises at least one of:
a total number of arithmetic operations of layers of the learning network,
a batch size used in the learning network, or
a total number of activation functions included in the learning network.

9. The apparatus of claim 7, wherein the performance prediction model is an inductive model configured to:
sample features from neighboring nodes of each node in graph data representing the learning network, and
aggregate the sampled features to generate node-embedding data, wherein the node-embedding data is used for generating the performance evaluation information.

10. The apparatus of claim 7, wherein:
the performance evaluation information comprises at least one of:
resource-utilization data of the target hardware executing the learning network, or
inference-performance data of the target hardware executing the learning network,
the resource-utilization data comprises at least one of:
latency of the target hardware,
memory usage of the target hardware, or
energy consumption of the target hardware, and
the inference-performance data comprises at least one of:
inference accuracy information of the learning network,
bottleneck-layer information of the learning network, or
solution information for enhancing the learning network.

11. An apparatus for a vehicle, the apparatus comprising:
a processor; and
a memory storing at least one instruction that, when executed by the processor, is configured to cause the apparatus to:
based on network representation information extracted from a learning network associated with the vehicle, generate relationship representation information, wherein the network representation information comprises a structure of the learning network and network configuration data of the learning network, and wherein the relationship representation information comprises:
adjacency data indicating a connection relationship between layers of the learning network, and
node feature data indicating a setting of hyperparameter applied to the layers of the learning network,
generate, based on the network representation information, static representation information, wherein the static representation information comprises overall operation data indicating a total operation amount for the layers of the learning network,
generate, by using a learning model of graph-based performance prediction and based on the relationship representation information and the static representation information, performance evaluation information of the learning network,
modify, based on the performance evaluation information, the learning network,
transmit, to the vehicle, the modified learning network, and
cause, based on the transmission of the modified learning network, control of the vehicle.

12. The apparatus of claim 11, wherein the structure of the learning network comprises the layers and connections between the layers,
wherein the connections indicate processing flows of the layers, and
wherein the network configuration data comprises the setting of the hyperparameter and an operation amount for each layer of the layers.

13. The apparatus of claim 11, wherein the at least one instruction, when executed by the processor, is configured to cause the apparatus to generate, by compilation of the learning network, the network representation information, and
wherein the network representation information comprises intermediate representation information related to the structure of the learning network and the network configuration data of the learning network.

14. The apparatus of claim 13, wherein the at least one instruction, when executed by the processor, is configured to generate, based on the structure, graph data,
wherein the graph data comprises nodes corresponding to the layers and edges indicating connections between the layers, and
wherein the nodes comprise node features associated with the network configuration data.

15. The apparatus of claim 11, wherein the overall operation data is generated based on:
a basic multiply-accumulate value of the learning network,
an operation amount of convolution included in the learning network,
an operation amount of a fully-connected layer included in the learning network,
a size of a batch included in the learning network, and
a number of activation functions included in the learning network.

16. The apparatus of claim 11, wherein the learning model of graph-based performance prediction is configured to:
process the relationship representation information to generate node embedding data,
concatenate the static representation information with the node embedding data, and
input the concatenated information into a fully connected layer to generate the performance evaluation information.

17. The apparatus of claim 11, wherein the learning model of graph-based performance prediction is an inductive model configured to:
sample features from neighboring nodes of each node in graph data representing the learning network, and
aggregate the sampled features to generate an embedding.

18. The apparatus of claim 11, wherein the learning model of graph-based performance prediction is trained using a loss function, wherein the loss function is configured to:
based on a difference between performance evaluation information output through training and performance evaluation information for ground-truth being less than or equal to a predetermined threshold, apply a mean square error, and
apply, based on the difference being greater than the predetermined threshold, an absolute value error.

19. The apparatus of claim 11, wherein the performance evaluation information comprises at least one of:
resource utilization data of a target hardware apparatus executing the learning network, or
inference performance data of the target hardware apparatus executing the learning network, and
wherein the resource utilization data comprises at least one of latency of the target hardware apparatus, memory usage of the target hardware apparatus, or energy consumption of the target hardware apparatus.

20. The apparatus of claim 19, wherein the inference performance data comprises at least one of:
inference accuracy data of the learning network,
bottleneck layer data of the learning network, or
solution data for optimization of the bottleneck layer data.
